(19) United States
(12) Patent Application Publication
(10) Pub. No.: US 2024/0242378 A1
(43) Pub. Date: Jul. 18, 2024

(54) IN-CABIN MONITORING METHOD AND RELATED POSE PATTERN CATEGORIZATION METHOD

(71) Applicant: Continental Automotive Technologies GmbH, Hannover (DE)

(72) Inventors: Lei Li, Singapore (SG); Mithun Das, Singapore (SG); Matthias Horst Meier, Singapore (SG); Sunil Kumar Thakur, Singapore (SG)

(73) Assignee: Continental Automotive Technologies GmbH, Hannover (DE)

(21) Appl. No.: 18/562,519

(22) PCT Filed: May 6, 2022
(86) PCT No.: PCT/EP2022/062239

§ 371 Date: Nov. 20, 2023

(30) Foreign Application Priority Data
May 20, 2021 (GB) 2107205.3

(51) Int. Cl. G06T 7/73; G06V 10/25; G06V 10/70; G06V 20/58; G06V 20/59; G06V 40/10

(52) U.S. Cl. CPC G06T 7/73; G06V 10/25; G06V 10/70; G06V 20/58; G06V 20/59; G06V 40/10; G06T 2207/20076; G06T 2207/20081; G06T 2207/30196; G06T 2207/30252; G06T 2207/30268

(57) ABSTRACT

The disclosure provides a computer implemented method for detecting an output pose of interest of a subject in real-time, the method comprising recording an image frame of the subject using an imaging device, determining an output pose of interest by processing the image frame using a machine learning model that comprises a rule-based pose inference model and a data-driven pose inference model wherein with the data-driven pose inference model, determining a data-driven pose of interest by processing a single frame of the subject, and wherein with the rule-based pose inference model, determining a rule-based output pose of interest by processing the same single image frame, and determining as the output pose of interest the rule-based output pose of interest, if the rule-based pose inference model is able to determine the rule-based output pose of interest, otherwise determining the data-driven pose of interest as the output pose of interest.

### CROSS REFERENCE TO RELATED APPLICATIONS

This U.S. patent application claims the benefit of PCT patent application No. PCT/EP2022/062239, filed May 6, 2022, which claims the benefit of GB patent application No. 2107205.3, filed May 20, 2021, both of which are hereby incorporated by reference.

### TECHNICAL FIELD

The disclosure relates to a pose pattern categorization method and an in-cabin monitoring method.

### BACKGROUND

US 2017/0 046 568 A1 discloses gesture recognition by use of a time sequence of frames that relate to body movement.

U.S. Pat. No. 9,904,845 B2 and U.S. Pat. No. 9,165,199 B2 discuss a 3D-image as a basis for pose estimation.

U.S. Pat. No. 9,690,982 B2 discloses considering angle and Euclidean distance between human key points or body parts for gesture detection. A class for input gesture data is inferred based on predefined rules by a trained machine learning model. The input gesture data depends on consecutive frames associated with a body movement.

US 2020/0 105 014 A1 also discloses inferring a class for input pose data based on predefined rules by a trained machine learning model.

U.S. Pat. No. 10,783,360 B1 discloses detecting vehicle operator gestures through in-cabin monitoring based on processing consecutive frames.

### SUMMARY

It is the object of the disclosure to provide improved methods and systems for pose categorization.

The disclosure provides a computer implemented method for detecting an output pose of interest of a subject in real-time, preferably the subject being inside a vehicle cabin or being in a surrounding environment of a vehicle, the method comprising: a) recording at least one image frame of the subject using an imaging device, b) determining an output pose of interest by processing the image frame using a machine learning model that comprises a rule-based pose inference model and a data-driven pose inference model wherein with the data-driven pose inference model, determining a data-driven pose of interest by processing a single image frame of the subject, wherein with the rule-based pose inference model, determining a rule-based output pose of interest by processing the same single image frame, and c) determining as the output pose of interest the rule-based output pose of interest, if the rule-based pose inference model is able to determine the rule-based output pose of interest in step b), otherwise determining the data-driven pose of interest as the output pose of interest.

In one embodiment, in step b) a plurality of human key points is extracted from the image frame, and the human key points are processed by the machine learning model.

In one embodiment, in step b) the data-driven pose of interest is determined by determining a probability score for each of at least one predetermined pose of interest and outputting as the data-driven pose of interest that pose among the predetermined poses of interest that has the highest probability score.

In one embodiment, in step b) the rule-based pose of interest is determined by comparing pose descriptor data with at least one set of pose descriptors that uniquely define a predetermined pose of interest, and outputting as the rule-based pose of interest that pose among the predetermined poses of interest that matches with the pose descriptor data or outputting that no match was found if the pose descriptor data does not match any of the pose descriptors of any predetermined pose of interest.

In one embodiment, the pose descriptor data is obtained by extracting a plurality of human key points from the image frame, and at least one of a Euclidean distance and an angle is determined from the human key points.

In one embodiment, in step c) the output pose of interest is determined by a summation of weighted rule-based poses of interest with the data-driven pose of interest, wherein the weight of the rule-based pose of interest that was determined to be in the image frame is set to 1 and the weight of the data-driven pose of interest is set to 0.

In one embodiment, in step c) no output pose of interest is determined, if the certainty determined for the presence of a predetermined pose of interest in the image frame is below a predetermined threshold.

In one embodiment, the method comprises a step of with a control unit, generating a control signal based on the output pose of interest determined in step c), the control signal being adapted to control a vehicle.

In one embodiment, in step a) the image frame is recorded from a subject inside a cabin of a vehicle and/or from a subject that is in a surrounding environment of a vehicle.

The disclosure provides an in-cabin monitoring method for monitoring a subject, preferable a vehicle driver, inside a vehicle cabin, the method comprising the performing of a preferred method, wherein the imaging device is arranged to image a subject inside a vehicle cabin, and the predetermined poses of interest are chosen to be indicative of abnormal driver behavior.

The disclosure provides a vehicle environment monitoring method for monitoring a subject that is present in a surrounding of the vehicle, the method comprising the performing of a preferred method, wherein the imaging device is arranged to image a subject in the surrounding environment of the vehicle, and the predetermined poses of interest are chosen to be indicative of pedestrian behavior.

The disclosure provides a pose categorization system configured for performing a preferred method, the pose categorization system comprising an imaging device configured for recording an image frame of a subject and a pose characterization device configured for determining an output pose of interest from a single image frame, wherein the pose categorization device comprises a data-driven pose inference model that is configured for determining a data-driven pose of interest by processing a single image frame of the subject and a rule-based pose inference model configured for determining a rule-based output pose of interest by processing the same image frame, wherein the pose categorization device is configured for determining as the output pose of interest the rule-based output pose of interest, if the rule-based pose inference model is able to determine the rule-based output pose of interest, otherwise determining the data-driven pose of interest as the output pose of interest.

The disclosure provides a vehicle comprising a pose categorization system.

The disclosure provides a computer program, or a computer readable storage medium, or a data signal comprising instructions, which upon execution by a data processing device cause the device to perform one, some, or all of the steps of a preferred method.

The disclosed end-to-end pose pattern categorization typically has three phases: Off-line model building phase; Online inference phase; and Model improve and optimization phase.

As per the detected human key points X and Y coordinates information, the specific angles within any 3 points may be calculated via triangle function, as well as the Euclidian distance between any 2 points, e.g. the right elbow angle θ among right shoulder, elbow and wrist (key points 6, 8, and 10) may be calculated as well as the Euclidian distance L between the person's or driver's nose and left hip (key points 0 and 11). Hence, the feature components of human pose patterns may be extracted and pre-defined according to the specific use case. For instance, if a person lays on the ground, the angle between the neck, hip and knee should be greater than a pre-defined configurable threshold e.g. 150 degrees; if a person is sitting on the seat, the distance between their shoulder and knee should be smaller than that when they are standing, etc. Those rules (stand, sit, sleep, etc.) may be taken into consideration for the later classification process.

The coordinates X and Y of the key points are another part of the human pose pattern component. In the scenario of a video image of a driver in a vehicle being captured by an internal camera, the driver's key points may be used to define and infer the pose patterns like hands-on/off steering wheel, head on steering wheel and the like. Hence, abnormal driver behavior may be pre-defined, trained, and inferred accordingly. The entire process includes below key steps: Data collection by usually recording a video in a real scenario with a targeted pose of interest (Pol). Human key points extraction by leveraging computer vision and deep learning techniques to identify and extract pre-defined human key points coordinates. Training a model using a supervised machine learning method based on processed and formulized data.

Instead of depending only on rule-based methods to classify the target pattern class, the solution presented herein incorporates with the pre-defined rules (angles and distance and etc.) and data driven methods which apply relative position of the human key points on the image to train a machine learning model (ML model) and infer a class output.

1) The training of the ML model is done by feeding a large amount of data to the model based on various supervised machine learning techniques including but not limited to tree-based, distance-based modeling, MLP and techniques which are flexible to stack together.

Specific multiple angles θ=(θ1, θ2, . . . , θn) and Euclidian distance L=(L1, L2, . . . , Ln) among different human key points may be calculated and included as separate features in the training structure tabular dataset. Configurable and flexible weights may be assigned to represent the importance of that feature, so that a comprehensive model that is combined with the knowledge of relative positions of body key points and hidden pose patterns can be trained.

2) The class output is inferred by taking into consideration a combination of pre-defined rules and a data-driven model prediction.

The model works as follows:

Define a total number of classes C=(c1, c2, . . . , cn), a weight of each class W=(w1, w2, . . . , wn), a prediction of the model P=(p1, p2, . . . , pn), and pre-defined rules for each class: fn(θ, L).

So, the weights of each class are defined as

$$( {w}_{1} , {w}_{2} , … , {w}_{n} ) = \{ \begin{matrix}{w}_{n} = 1 , {w}_{1} = {w}_{2} = … = {w}_{n - 1} = 0 ; & ( θ , L ) ϵ {f}_{n} ( θ , L ) \\ {w}_{1} = {w}_{2} = … = {w}_{n} = 0 ; & otherwise\end{matrix}$$

The overall output t is defined as below

$$tn = w 1 c 1 + w 2 c 2 + … + wncn + ( 1 - w 1 ) ( 1 - w 2 ) … ( 1 - wn ) pn$$

meaning when the condition θ, L meets the definition of the n-th class cn, the overall class output tn will only take the n-th class cn regardless of the model prediction, otherwise the prediction from the model will dominate the overall class output regardless of the pre-defined rules, e.g. first define the rule of the pose pattern “sleeping” as the angle θ among neck, hip, and knee is greater than 150 degrees, if the requirement is met, then the output of the pose will be “sleeping” regardless of the model prediction, otherwise take the prediction as the class output.

The real-time inference task applies the trained model to classify and detect the Pose of Interest (Pol) accordingly. For each input frame, there will be a predicted class and its probability score to present the confidence level which can help to optimize the model.

The model is adaptive and flexible as per the specific use cases, meaning different models are trained to solve the pose pattern categorization problem in different scenarios, at the end of evaluation step, more feature engineering approaches and techniques may be introduced to improve and optimize the accuracy to achieve better performance.

This solution does not need a special depth sensor, allows for easier model building, improves flexibility of target pose classes definition, may be integrated into any system straightforward, and improves accuracy based on a better attunement with the input training data.

### BRIEF DESCRIPTION OF THE FIGURES

An embodiment of the disclosure is described in more detail with referenced to the accompanying schematic drawings. Therein:

FIG. 1 depicts an embodiment of a pose categorization system;

FIG. 2 depicts an embodiment of a pose categorization method; and

FIG. 3 illustrates key human body points.

### DETAILED DESCRIPTION

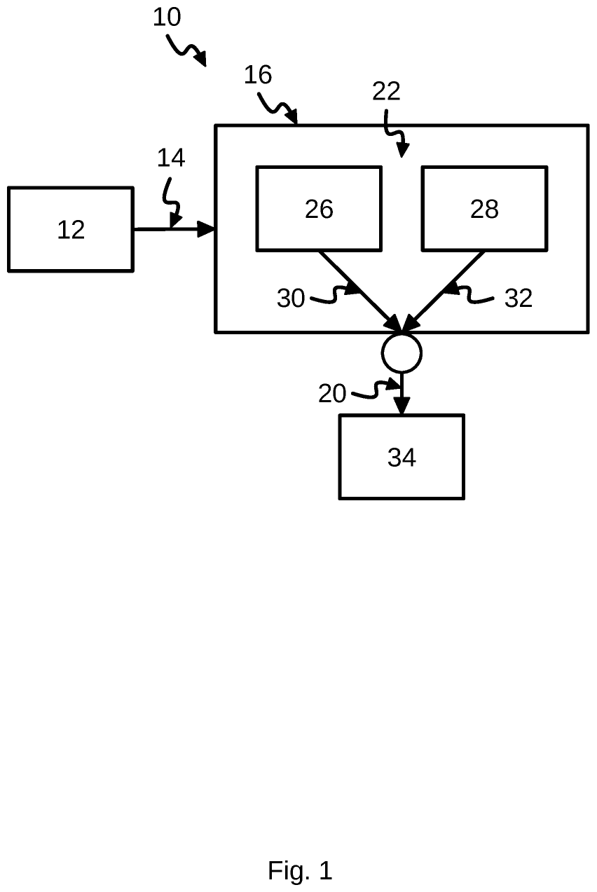

FIG. 1 illustrates an embodiment of a pose categorization system 10 as it may be used in a vehicle, e.g. for in-cabin monitoring or environment monitoring of the environment outside the vehicle.

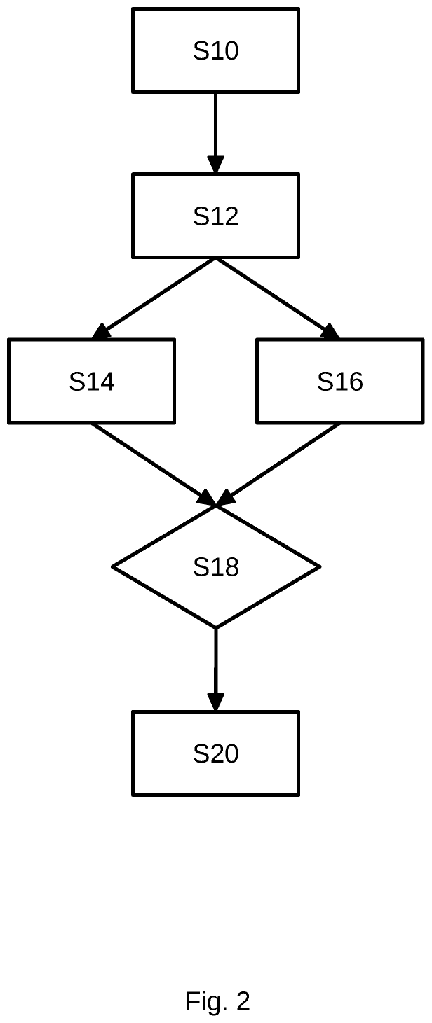

The pose categorization system 10 comprises an imaging device 12. The imaging device 12 for example includes a video camera. In an imaging step S10 (FIG. 2), the imaging device 12 records an image frame 14 of a subject/person.

The pose categorization system 10 comprises a pose categorization device 16. The pose categorization device 16 is configured to process the image frame 14 from the imaging device 12 and determine an output pose of interest 20. The pose categorization device 16 is configured as a rule-based and data-driven device.

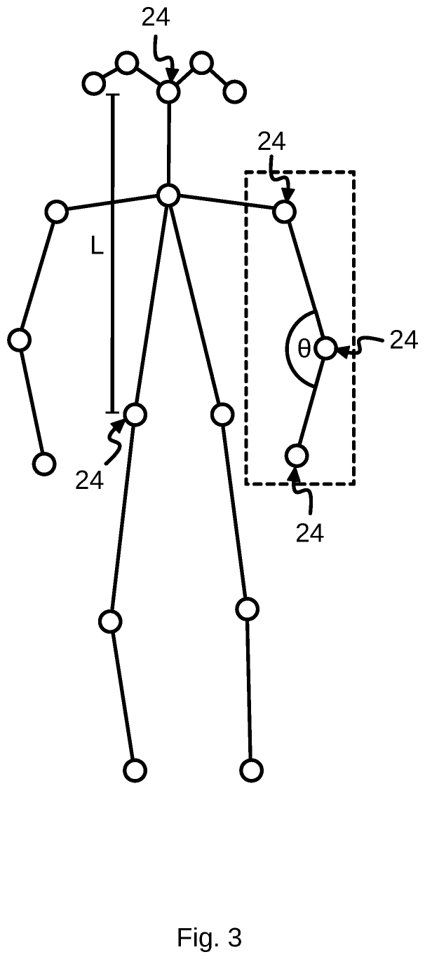

The pose categorization device 16 includes a machine learning model 22. The machine learning model 22 is trained to classify a plurality of human key points 24 (FIG. 3) as belonging to a predetermined pose of interest, such as ‘standing’, ‘sitting’, ‘laying down’, etc. The training is done using a supervised machine learning method based on processed and formulized data. The human key points 24 are extracted from a single image frame 14 by the pose categorization device 16 in a extraction step S12 (FIG. 2). The human key points 24 are indicative of important locations of the human body, such as eyes, joints (elbow, knees, hips, etc.), hands and feet, etc.

The machine learning model 22 includes a data-driven pose inference model 26 and a rule-based pose inference model 28.

The data-driven pose inference model 26 is configured to output a data-driven pose of interest 30 by analyzing the human key points 24 and determining a probability for each predetermined pose of interest, which is done in a data-driven step S14 (FIG. 2). The data-driven pose inference model 28 outputs as the data-driven pose of interest 30 the predetermined pose of interest that has scored the highest probability.

The rule-based pose inference model 28 includes a set of pose descriptors each describing one of the predetermined poses of interest. The pose descriptor includes at least a range of Euclidean distances L between two human key points 24 and a range of angles θ between three human key points 24. In a rule-based step S16 (FIG. 2), pose descriptor data are extracted from the human key points 24 and compared with the pose descriptors of each predetermined pose of interest. The rule-based pose inference model 28 outputs as a rule-based pose of interest 32 the predetermined pose of interest that best fits that poses pose descriptors, i.e. has the smallest deviation from them. If none of the extracted pose descriptor data matches the pose descriptors of the predetermined poses of interest 30, then not rule-based pose of interest 32 is determined.

In an output step S18 (FIG. 2), the pose categorization device 16 selects as the output pose of interest 20 either the rule-based pose of interest 32 or, if no rule-based pose of interest 32 may be determined, the data-driven pose of interest 30.

The pose categorization device 16 may also include a threshold that allows to determine, whether a predetermined pose is sufficiently well established to be output as the output pose of interest 20.

In other words, if the rule-based categorization in step S16 fails, then the data-driven pose of interest 30 is only output as the output pose of interest 20, if the probability of the data-driven pose of interest 30 was determined to be above the threshold. The threshold may be varied according to factors within the vehicle cabin or the environment. For example, the threshold may be set lower for daytime or light conditions (e.g. between 30% and 50%) and higher for nighttime or darkness conditions (e.g. between 70% and 90%).

The pose categorization system 10 may further comprise a control unit 34 that is configured to generate a control signal for a vehicle based on the output pose of interest 20, in a control step S20.

For example, the pose categorization system 10 images a driver of a vehicle and classifies the driver's pose as ‘hands not on steering wheel’, the control unit 34 may cause the vehicle to call for the driver's attention. Other poses are possible, in particular poses that relate to abnormal driving behavior, e.g. being tired, distracted or under the influence.

In another example, the pose categorization system 10 images the environment of the vehicle and determines the pose of a pedestrian as to be ‘standing’. The control unit 34 may then cause the vehicle to activate further sensors or prepare an emergency breaking procedure etc.

With the measures described herein there is no need for consecutive frames for pose pattern recognition. Therefore, the system and method are better able to tolerate real-time frame losses or noise. Due to the hybrid of rule-based and data-driven analysis, more pose patterns can be recognized with greater accuracy, including fine tune patterns, thereby allowing for a more granular pattern recognition methodology. In addition, this solution is better scalable compared to other solutions. There is also no need for 3D data. The overall light weight approach allows for faster inference for edge-processing embedded systems and devices.

1. A computer implemented method for detecting an output pose of interest of a subject in real-time, the method comprising:
recording at least one image frame of the subject using an imaging device;
determining an output pose of interest by processing the image frame using a machine learning model that comprises a rule-based pose inference model and a data-driven pose inference model,
wherein with the data-driven pose inference model, determining a data-driven pose of interest by processing a single image frame of the subject, and
wherein with the rule-based pose inference model, determining a rule-based output pose of interest by processing the same single image frame; and
determining as the output pose of interest the rule-based output pose of interest, if the rule-based pose inference model is able to determine the rule-based output pose of interest, otherwise determining the data-driven pose of interest as the output pose of interest.

2. The method according to claim 1, wherein a plurality of human key points is extracted from the image frame, and the human key points are processed by the machine learning model.

3. The method according to claim 1, wherein the data-driven pose of interest is determined by determining a probability score for each of at least one predetermined pose of interest and outputting as the data-driven pose of interest that pose among the predetermined poses of interest that has the highest probability score.

4. The method according to claim 1, wherein the rule-based pose of interest is determined by comparing pose descriptor data with at least one set of pose descriptors that uniquely define a predetermined pose of interest, and outputting as the rule-based pose of interest that pose among the predetermined poses of interest that matches with the pose descriptor data or outputting that no match was found if the pose descriptor data does not match any of the pose descriptors of any predetermined pose of interest.

5. The method according claim 4, wherein the pose descriptor data is obtained by extracting a plurality of human key points from the image frame, and at least one of a Euclidean distance and an angle is determined from the human key points.

6. The method according to claim 1, wherein the output pose of interest is determined by a summation of weighted rule-based poses of interest with the data-driven pose of interest, wherein the weight of the rule-based pose of interest that was determined to be in the image frame is set to 1 and the weight of the data-driven pose of interest is set to 0.

7. The method according to claim 1, wherein no output pose of interest is determined, if the certainty determined for the presence of a predetermined pose of interest in the image frame is below a predetermined threshold.

8. The method according to claim 1,
further comprising generating a control signal with a control unit based on the output pose of interest, the control signal being adapted to control a vehicle.

9. The method according to claim 1, wherein the image frame is recorded from a subject inside a cabin of a vehicle and/or from a subject that is in a surrounding environment of a vehicle.

10. An in-cabin monitoring method for monitoring a subject inside a vehicle cabin, the method comprising:
recording at least one image frame of the subject using an imaging device wherein the imaging device is arranged to image the subject inside the vehicle cabin;
determining an output pose of interest by processing the image frame using a machine learning model that comprises a rule-based pose inference model and a data-driven pose inference model,
wherein with the data-driven pose inference model, determining a data-driven pose of interest by processing a single image frame of the subject, wherein the data-driven pose of interest is determined by determining a probability score for each of at least one predetermined pose of interest and outputting as the data-driven pose of interest that pose among the predetermined poses of interest that has the highest probability score, wherein the predetermined poses of interest are chosen to be indicative of abnormal driver behavior, and
wherein with the rule-based pose inference model, determining a rule-based output pose of interest by processing the same single image frame, wherein the rule-based pose of interest is determined by comparing pose descriptor data with at least one set of pose descriptors that uniquely define a predetermined pose of interest, and outputting as the rule-based pose of interest that pose among the predetermined poses of interest that matches with the pose descriptor data or outputting that no match was found if the pose descriptor data does not match any of the pose descriptors of any predetermined pose of interest, wherein the predetermined poses of interest are chosen to be indicative of abnormal driver behavior; and
determining as the output pose of interest the rule-based output pose of interest, if the rule-based pose inference model is able to determine the rule-based output pose of interest, otherwise determining the data-driven pose of interest as the output pose of interest.

11. A vehicle environment monitoring method for monitoring a subject that is present in a surrounding of the vehicle, the method comprising:
recording at least one image frame of the subject using an imaging device wherein the imaging device is arranged to image the subject in the surrounding environment of the vehicle;
determining an output pose of interest by processing the image frame using a machine learning model that comprises a rule-based pose inference model and a data-driven pose inference model,
wherein with the data-driven pose inference model, determining a data-driven pose of interest by processing a single image frame of the subject, wherein the data-driven pose of interest is determined by determining a probability score for each of at least one predetermined pose of interest and outputting as the data-driven pose of interest that pose among the predetermined poses of interest that has the highest probability score, wherein the predetermined poses of interest are chosen to be indicative of pedestrian behavior, and
wherein with the rule-based pose inference model, determining a rule-based output pose of interest by processing the same single image frame, wherein the rule-based pose of interest is determined by comparing pose descriptor data with at least one set of pose descriptors that uniquely define a predetermined pose of interest, and outputting as the rule-based pose of interest that pose among the predetermined poses of interest that matches with the pose descriptor data or outputting that no match was found if the pose descriptor data does not match any of the pose descriptors of any predetermined pose of interest, wherein the predetermined poses of interest are chosen to be indicative of pedestrian behavior; and
determining as the output pose of interest the rule-based output pose of interest, if the rule-based pose inference model is able to determine the rule-based output pose of interest, otherwise determining the data-driven pose of interest as the output pose of interest.

12. A pose categorization system, comprising:
an imaging device configured for recording an image frame of a subject; and
a pose characterization device configured for determining an output pose of interest from a single image frame, wherein the pose categorization device comprises a data-driven pose inference model that is configured for determining a data-driven pose of interest by processing a single image frame of the subject and a rule-based pose inference model configured for determining a rule-based output pose of interest by processing the same image frame, wherein the pose categorization device is configured for determining as the output pose of interest the rule-based output pose of interest, if the rule-based pose inference model is able to determine the rule-based output pose of interest, otherwise determining the data-driven pose of interest as the output pose of interest.

13. The pose categorization system according to claim 12, wherein the system is located in a vehicle.

14. A computer program, or a computer readable storage medium, or a data signal comprising instructions, which upon execution by a data processing device cause the device to perform one, some, or all of the steps of a method, the method comprising:
recording at least one image frame of the subject using an imaging device;
determining an output pose of interest by processing the image frame using a machine learning model that comprises a rule-based pose inference model and a data-driven pose inference model, wherein with the data-driven pose inference model, determining a data-driven pose of interest by processing a single image frame of the subject, and wherein with the rule-based pose inference model, determining a rule-based output pose of interest by processing the same single image frame; and
determining as the output pose of interest the rule-based output pose of interest, if the rule-based pose inference model is able to determine the rule-based output pose of interest, otherwise determining the data-driven pose of interest as the output pose of interest.
